(19) United States
(12) Patent Application Publication
(10) Pub. No.: US 2017/0205868 A1
(43) Pub. Date: Jul. 20, 2017

(54) METHOD OF ANALYZING POWER USAGE AND ELECTRONIC APPARATUS THEREOF

(71) Applicant: TATUNG COMPANY, TAIPEI (TW)

(72) Inventor: I-HSIANG HUANG, TAIPEI CITY (TW)

(21) Appl. No.: 15/001,139

(22) Filed: Jan. 19, 2016

(51) Int. Cl. G06F 1/32; G06F 11/32

(52) U.S. Cl. CPC G06F 1/3209; G06F 11/328

(57) ABSTRACT

A method of analyzing power usage and an electronic apparatus are provided. The method includes the following steps. Power usage data from power usage recording devices within a time interval are collected, wherein each of the power usage data includes a plurality of data points. A dissimilarity between every two of the collected power usage data is calculated. The collected power usage data are classified according to the dissimilarities into a plurality of classifications. The power usage data are displayed, wherein the power usage data belonging to different classifications are shown by different colors.

### BACKGROUND OF THE INVENTION

Field of the Invention

The invention relates to an analysis method and an electronic apparatus thereof, and particularly relates to a method of analyzing power usage and an electronic apparatus thereof.

Description of Related Art

Along with increased awareness on energy saving and cost reduction, power usage monitoring and power usage management have become crucial issues in recent years. To owners of the buildings and the factories, a comprehensive analysis of the power consumption is important, from which the owners may find their electricity usage pattern, and thus propose proper electricity planning and control the power bill. From another aspect, a comprehensive analysis of the power consumption is also important to a power company. The power company may evaluate the total required electricity, properly deliver the power to each of the clients and charge the power fee from each of the clients according to the power consumption analysis based on the power usage data collected from all the clients.

For a century, the power company have had to send workers out to collect the power usage data from the clients, so as to properly deliver the power and correctly charge the power bill. However, along with the development and the progress of the technology and the electronic industry, many options and devices are provided for the power company, from which the power usage data of the clients may be automatically collected and stored. However, there is still a lack of analysis method for effectively utilizing large amount of the power usage data and adequately classifying the power usage data according to their pattern. Thus, it is still a goal of effort for those technicians of the field to provide an efficient and accurate power usage analysis method and an electronic apparatus thereof.

### SUMMARY OF THE INVENTION

The invention is directed to a method of analyzing power usage and an electronic apparatus thereof, by which large amount of the power usage data is effectively arranged, classified and further displayed.

An embodiment of the invention provides a method of analyzing power usage, adapted to an electronic apparatus. The method includes the following steps. Power usage data are collected from power usage recording devices within a time interval, wherein each of the power usage data includes a plurality of data points. Dissimilarity between every two of the collected power usage data is calculated. The collected power usage data are classified into a plurality of classifications according to the dissimilarities. The power usage data are displayed, wherein the power usage data belonging to the different classification are shown by different colors.

In an embodiment of the invention, collecting the power usage data further includes the following step. The data points recorded once every period within the time interval by the power usage recording devices are collected from the power usage recording devices to obtain the power usage data.

In an embodiment of the invention, calculating the dissimilarity between two of the collected power usage data further includes the following steps. A product between each pair of the data points collected at a corresponding timing from the two collected power usage data is calculated. All the products are summed to obtain a sum of product between the two collected power usage data. A first square root of sum of squares (SRSS) of the data points from one of the two collected power usage data is calculated. A second SRSS of the data points from another one of the two collected power usage data is calculated. An SRSS product of the first SRSS and the second SRSS is calculated. The sum of product is divided by the SRSS product to obtain a result value. The dissimilarity between two of the collected power usage data is obtained by subtracting the result value from 1.

In an embodiment of the invention, when one of the first SRSS and the second SRSS is 0, the result value is set to be 0, and when both of the first SRSS and the second SRSS are 0, the result value is set to be 1.

In an embodiment of the invention, before calculating the dissimilarity between every two of the collected power usage data, the method further includes the following steps. A ratio is determined to obtain a selected number from a total number of the data points within the single collected power usage data. A group of weightings is obtained, wherein the number of weightings equals to the selected number, and a distribution of the weightings is corresponding to a bell shape. The weightings are utilized to selectively smooth the power usage data or to selectively obtain a tendency curve of the data points in each of the power usage data. At least one of the power usage data is selectively time-shifted.

In an embodiment of the invention, classifying the collected power usage data into the plurality of classifications further includes the following steps. The number of the classifications and sets of initial reference points for the classifications are determined, wherein each of the classifications is corresponding to one of the sets of the initial reference points. Each of the power usage data is allocated into one of the classifications according to the dissimilarities, wherein a distortion between the allocated power usage data and the set of the initial reference points of the classification which the power usage data belonging to is lower than the distortion between the allocated power usage data and the at least one set of the initial reference points of the other classification. Sets of reference points for the classifications are calculated based on the allocated power usage data, wherein each of the classifications is corresponding to one of the sets of the reference points. Each of the power usage data is reallocated into one of the classifications, wherein the distortion between the reallocated power usage data and the set of the reference points of the classification which the reallocated power usage data belonging to is lower than the distortion between the reallocated power usage data and the at least one set of the reference points of the other classification.

In an embodiment of the invention, determining the number of the classifications and the sets of the initial reference points for classifications further includes the following steps. (a). One power usage data is randomly selected from the collected power usage data as the set of the initial reference points. (b). A first norm value between each of the power usage data and each of the at least one set of the initial reference points is calculated, wherein each of the power usage data is corresponding to the at least one first norm value. (c). For each of the power usage data, the lowest first norm value corresponding to the power usage data is selected to determine a priority value. (d). The power usage data having the largest priority value as one set of the initial reference points is selected.

In an embodiment of the invention, determining the number of the classifications and the sets of the initial reference points for classifications further includes the following steps. (e). Whether the largest priority value of all the priority values is smaller than a threshold value is determined. If the largest priority value is smaller than the threshold value, the sets of the initial reference points are determined, and the number of the sets of the initial reference points is the number of the classifications. If the largest priority value is not smaller than the threshold value, the steps (b) to (e) are executed again.

In an embodiment of the invention, wherein the priority value is a square value of the lowest first norm value corresponding to the power usage data when the number of the set of the initial reference points is lower than 3, and the priority value is a division of the square value of the lowest first norm value and a sum of the square values of the first norm values corresponding to the power usage data when the number of the set of the initial reference points is not lower than 3.

In an embodiment of the invention, wherein before the step (a), the method further includes the following steps. An average value of each of the power usage data is calculated. For each of the power usage data, a plurality of second norm values between each of the data points and the average value are calculated. For each of the power usage data, square values of all the corresponding second norm values are summed to obtain a data summation value. The data summation values corresponding to the power usage data are arranged to a data value sequence. A first intermediate value sequence is obtained, wherein bₜₕ term of the first intermediate value sequence is a total summation value of first term to bₜₕ term of the data value sequence. A second intermediate value sequence is obtained, wherein lₜₕ term of the second intermediate value sequence is a square value of a third norm value between the (l+1)ₜₕ term and the lₜₕ term of the first intermediate value sequence. A third intermediate value sequence is obtained, wherein mₜₕ term of the third intermediate value sequence is a square value of a fourth norm value between the (m+1)ₜₕ term and the mₜₕ term of the second intermediate value sequence. A fourth intermediate value sequence is obtained, wherein qₜₕ term of the fourth intermediate value sequence is a square value of a fifth norm value between the (q+1)ₜₕ term and the qₜₕ term of the third intermediate value sequence. The number of the classifications is determined, wherein the number of the classification is the q which results the maximum square value of the fifth norm value, b, l, m, q are positive integers, and b is equal to the number of the power usage data. The steps (b) to (d) are repeatedly executed until the number of the sets of the initial reference points equals to the number of the classifications.

In an embodiment of the invention, calculating the sets of reference points for the classifications based on the allocated power usage data and reallocating each of the power usage data into one of the classifications are repeated until the distortions between each of the reallocated power usage data and the set of the reference points of the corresponding classification which the reallocated power usage data belonging to are not being decreased.

In an embodiment of the invention, displaying the power usage data further includes the following steps. The colors from a color space is selected according to the number of the classifications, wherein the number of the selected colors is equal to the number of the classifications, and each of the selected colors has greatest difference to other selected colors. The power usage data in one of the classifications is displayed with one of the selected colors, wherein the colors of the classifications are different.

In an embodiment of the invention, displaying the power usage data further includes the following steps. Multidimensional scaling on each of the power usage data is applied to obtain a plurality of representative points in a two-dimensional space. The representative points are displayed in a scattering plot, wherein the scattering plot is divided into a plurality of grids, each of the grids includes a plurality of pixels, and each of the representative points occupies a first region of the grids. A detection range for each of the representative points on the scattering plot is set, wherein the detection range covers the first region of the grids and a second region of the grids around the first region. The representative points and the corresponding detection ranges on the scattering plot are recorded.

In an embodiment of the invention, the method further includes the following steps. A click on the scattering plot is detected. Whether the click is located at the recorded detection range is determined. If the click is not located at the recorded detection range, a warning message is displayed. If the click is located at the recorded detection range, the corresponding representative point and the corresponding power usage data are obtained, and the first region of the representative point corresponding to the recorded detection range where the click is located at is labeled with a specific color. The at least one power usage data corresponding to the at least one representative point intended to be clicked is displayed.

Another embodiment of the invention provides an electronic apparatus. The electronic apparatus includes a transmission unit, a processing unit and a display unit. The transmission unit connected to power usage recording devices collects power usage data from the power usage recording devices within a time interval, wherein each of the power usage data includes a plurality of data points. The processing unit calculates dissimilarity between every two of the collected power usage data, and classifies the collected power usage data into a plurality of classifications according to the dissimilarities. The display unit displays the power usage data, wherein the power usage data belonging to the different classifications are shown by different colors.

According to the above description, in the method of analyzing power usage and the electronic apparatus thereof, power usage data are collected, and the dissimilarity between every two of the power usage data is calculated. The collected power usage data are further classified according to the calculated dissimilarities and displayed. As the result, the power usage data having the similar patterns are put into the same classification and visualized with the same color. Thus, large amount of the power usage data is effectively arranged, classified and further displayed through the power usage analysis method and the electronic apparatus provided in the present invention.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating an electronic apparatus according to an embodiment of the present invention.

FIG. 2 is a flowchart illustrating a method of analyzing power usage according to an embodiment of the present invention.

FIG. 3 is a flowchart illustrating steps of the power usage analysis method before calculating the dissimilarities according to an embodiment of the present invention.

FIG. 4 is a schematic diagram illustrating the power usage data, the smoothed power usage data and the tendency curve of the power usage data according to an embodiment of the present invention.

FIG. 5 is a flowchart illustrating calculating a dissimilarity according to an embodiment of the present invention.

FIG. 6 is a flowchart illustrating classifying the collected power usage data into the plurality of classifications according to an embodiment of the present invention.

FIG. 7 is a flowchart illustrating determining the number of the classifications and the sets of the initial reference points according to an embodiment of the present invention.

FIG. 8A and FIG. 8B are a flowchart illustrating determining the number of the classifications and the sets of the initial reference points according to another embodiment of the present invention.

FIG. 9 is a schematic diagram illustrating the power usage data respectively allocated in each of the classifications according to an embodiment of the present invention.

FIG. 10 is a schematic diagram illustrating a scattering plot with representative points according to an embodiment of the present invention.

FIG. 11 is a schematic diagram illustrating a representative point according to an embodiment of the present invention.

FIG. 12 is a flowchart illustrating displaying power usage data corresponding to the selected representative point according to an embodiment of the present invention.

### DESCRIPTION OF EMBODIMENTS

Within embodiments of the present invention, a method of analyzing power usage and an electronic apparatus thereof are proposed. Specifically, the proposed method and the electronic apparatus thereof utilize power usage data collected from buildings, apartments, factories, home units and other kinds of architecture. With assistance of the proposed method and the electronic apparatus thereof, both user and manager of the power plant can easily recognize the power usage condition and the power usage pattern of any of the buildings, apartments, factories, home units and other kinds of architecture.

The power usage data mostly collected by power usage recording devices. In an embodiment of the present invention, the power usage recording device is, for example, a smart power meter, but it is not limited herein. The power usage recording device records energy consumption of the building, the apartment, the factory, the time unit or the other architecture in periods of a day, an hour, a half hour, 10 minutes, 5 minutes, 1 minutes, 30 seconds or less. After a predetermined interval of time, the power usage recording device further transmits the recorded data back to the utility for monitoring and billing. In another embodiment, the power usage recording device may also transmit the recorded data back to the utility in real time.

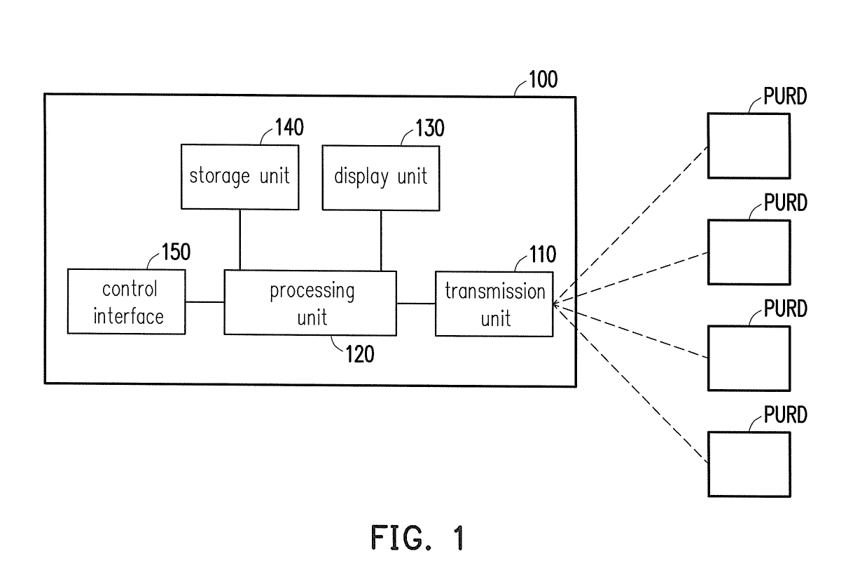

FIG. 1 is a block diagram illustrating an electronic apparatus according to an embodiment of the present invention. Referring to FIG. 1, in the present embodiment of the invention, the method of analyzing power usage is implemented by the electronic apparatus 100, but the invention is not limited to the current embodiment. In other words, the proposed method analyzing power usage may also be implemented by other kinds of electronic apparatus and device. The electronic apparatus 100 is connected to the power usage recording devices via wired or wireless connection.

To be more specific, in the present embodiment, the electronic apparatus 100 is an electronic apparatus with computation ability, such as a personal computer, a laptop computer, a tabular computer, a server and a smart device, but the invention is not limited herein. The electronic apparatus 100 at least includes a transmission unit 110, a processing unit 120, a display unit 130, a storage unit 140 and a control interface 150.

In the present embodiment, the transmission unit 110 connected to power usage recording devices PURD is, for example, a communication module supporting various wireless communication standards such as Bluetooth protocol, Wireless Fidelity (Wi-Fi) protocol, WiMAX (Worldwide Interoperability for Microwave Access) protocol, Zigbee protocol, LTE (Long Term Evolution) protocol, NFC (Near Field Communication) protocol and so on. In another embodiment of the present invention, the transmission unit 110 further supports the wire communication standards such as Asymmetric Digital Subscriber Line (ADSL) communication standard.

In the present embodiment, the processing unit 120 coupled to the transmission unit 110, the display unit 130, the storage unit 140 and the control interface 150 is a central processing unit (CPU), a programmable microprocessor, a digital signal processor (DSP), a programmable controller, an application specific integrated circuit (ASIC) or a programmable logic device (PLD), for example, but not limited thereto.

In the present embodiment, the display unit 130 for displaying images is built in the electronic apparatus 100. Moreover, the display unit 130 is a liquid crystal (LC) display unit, a light-emitting diode (LED) display unit or an organic LED (OLED) display unit, for example, but not limited thereto. In another embodiment of the present invention, the display unit 130 may be separated from the electronic apparatus 100.

In the present embodiment, the storage unit 140 for storing data is a hard disk drive (HDD) of any type, a random access memory (RAM), a read-only memory (ROM), a flash memory, or a combination of the foregoing, for example, but not limited thereto.

In the present embodiment, the control interface 150 is a keyboard, a keypad, a mouse device or a touch control panel, for example, but not limited thereto. In addition, when the control interface 150 is the touch control panel, the control interface 150 and the display unit 130 may be integrated as a touch display screen. Specifically, the control interface 150 is provided for controlling the electronic apparatus 100, from which the commands and the instructions could be inputted into the electronic apparatus 100.

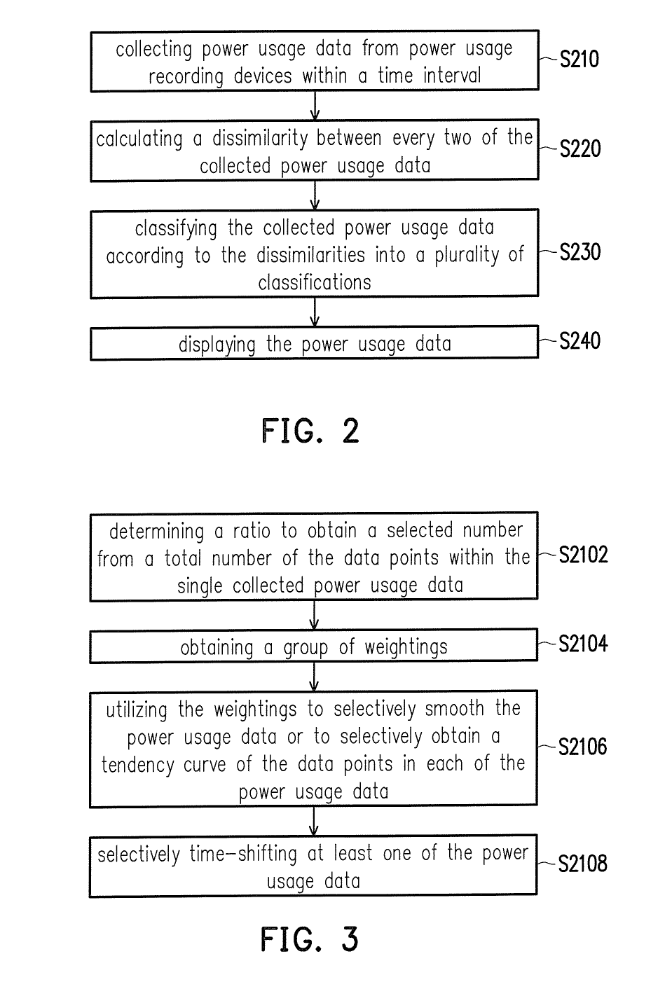

FIG. 2 is a flowchart illustrating a method of analyzing power usage according to an embodiment of the present invention. Referring to FIG. 1 and FIG. 2 together, the method of analyzing power usage includes the following steps. Power usage data within a time interval are collected by the transmission unit 110 from the power usage recording devices PURD (step S210), wherein each of the power usage data includes a plurality of data points.

As stated above, each of the power usage recording devices PURD may record the energy consumption condition, especially the electricity consumption condition, once in every period of a day, an hour, a half hour, 10 minutes, 5 minutes, 1 minutes, 30 seconds or less. In other words, the power usage recording devices PURD record the electricity consumption as a data point in every period within a time interval. After the time interval, each of the power usage recording devices PURD transmits all the data points as the power usage data to the electronic apparatus 100. The time interval may be a month, half of a month, a week, three days or a day, but it is not limited thereto. As the result, the transmission unit 110 of the electronic apparatus 100 collects the data points, recorded once every period within the time interval, to obtain the power usage data from all the connected power usage recording devices PURD.

Referring to FIG. 1 and FIG. 2, after the power usage data are collected, a dissimilarity between every two of the collected power usage data is calculated (step S220). However, prior to calculating the dissimilarities, several processes, such as smoothing, time-shifting, are further performed to the collected power usage data by the processing unit 120.

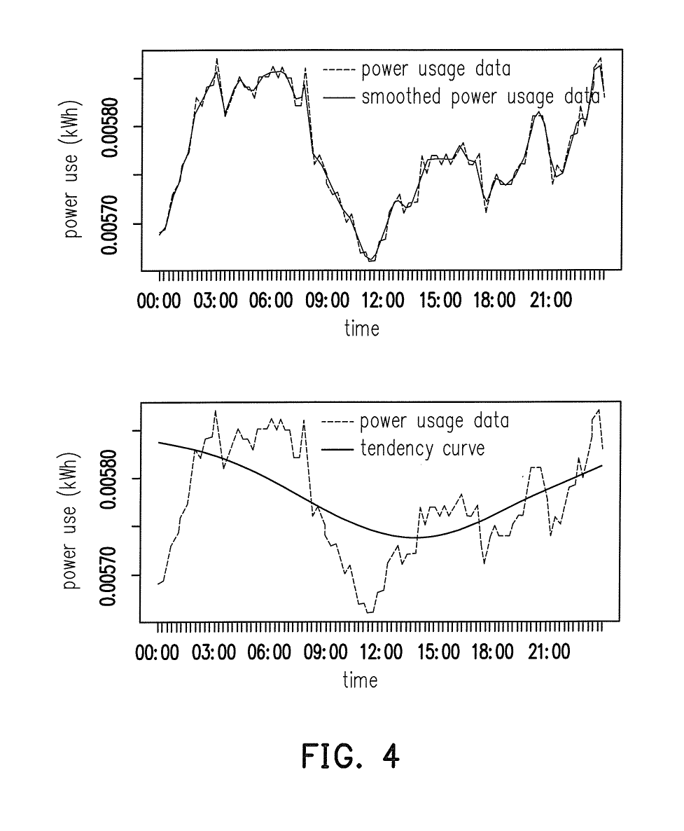

FIG. 3 is a flowchart illustrating steps of the power usage analysis method before calculating the dissimilarities according to an embodiment of the present invention. Referring to FIG. 3, a ratio r is first determined to obtain a selected number p of the data points from a total number n of the data points within the single collected power usage data by the processing unit 120 (step S2102). For detail, the selected number p is obtained as follows.

p=nr (1)

It should be noted that, n, p are both positive integer, and r is between 0 and 1 (0≦r≦1). Next, the processing unit 120 obtains a group of the weightings (step S2104), and the weightings are utilized by the processing unit 120 to selectively smooth the power usage data or to selectively obtain a tendency curve of the data points in each of the power usage data (step 2106). To be more specific, for the data points xᵢ within the signal power usage data, the goal is to obtain the fitted value \tilde{y}(vⱼ) at vⱼ as follows.

\tilde{y}(vⱼ)=Σₖ₌₀^{d}cₖ_{ⱼ}vⱼ^{k} (2)

It should be noted that, i represents 1, 2, . . . , n, and vⱼ represents the evenly separated x values (data points). Further, d is the degree of the polynomial fitted to the data points. The cₖ should minimize the value of the following expression.

$$\begin{matrix}{w}_{i} ( {v}_{j} ) = \{ \begin{matrix}{( 1 - {{E}_{i} ( {v}_{j} )}^{{λ}_{1}} )}^{{λ}_{2}} , & {E}_{i} ( {v}_{j} ) < 1 , ( {λ}_{1} , {λ}_{2} ) \geq 2 \\ 0 , & otherwire\end{matrix} & ( 4 ) \\ {E}_{i} ( {v}_{j} ) = \frac{{e}_{i} ( {v}_{j} )}{{e}_{p} ( {v}_{j} )} , & ( 5 ) \\ {e}_{i} ( {v}_{j} ) = \vert {x}_{i} - {v}_{j} \vert & ( 6 )\end{matrix}$$

The yᵢ is one of the fitted values, and wᵢ (vᵢ) is the corresponding weighting. The group of the weightings wᵢ (vᵢ) is obtained as follows.

$${\sum }_{i = 1}^{n} {w}_{i} ( {v}_{i} ) {( {y}_{i} - {\sum }_{k = 0}^{d} {c}_{{k}_{j}} {x}_{i}^{k} )}^{2} \qquad ( 3 )$$

It should be noted that, Eᵢ(vⱼ)≦1 when data points xᵢ is the selected data point, which means the data point falls in a range of the selected number p of the data points. On the contrary, when data points xᵢ is not the selected data point, which means the data point falls outside the range of the selected number p of the data points, Eᵢ(vⱼ)>1.

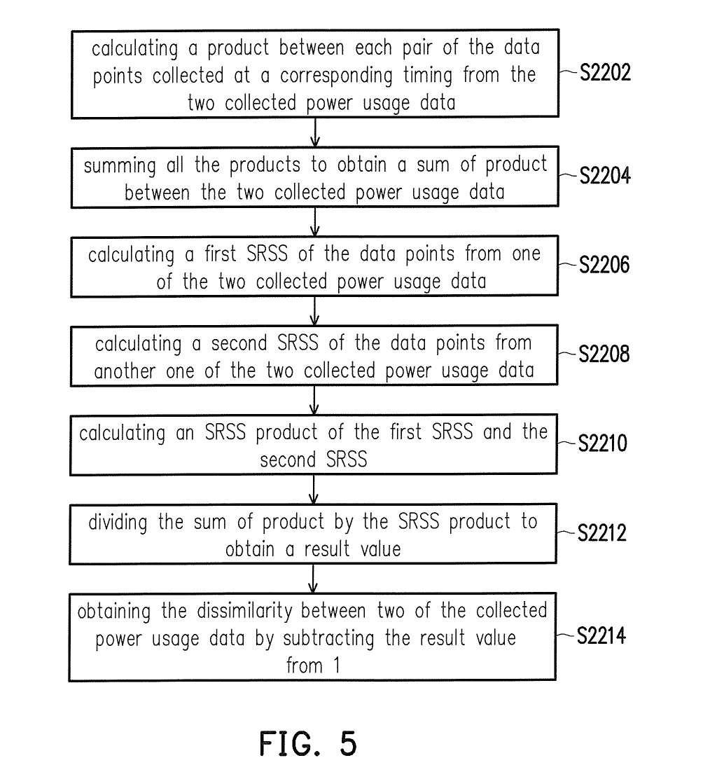

Based on the above description, the group of the weightings is first obtained, and then the power usage data is smoothed or the tendency curve of the data points in each of the power usage data is obtained through the use of the weightings. FIG. 4 is a schematic diagram illustrating the power usage data, the smoothed power usage data and the tendency curve of the power usage data according to an embodiment of the present invention. Referring to FIG. 4, the horizontal axis represents the time (0:00˜24:00, 24-hour time notation), and the vertical axis represents the power use (kilowatt hour, kWh). The number of the weightings equals to the selected number p, and the distribution of the weightings is corresponding to a bell shape. Moreover, the determination of the ratio r in step S2102 has the impact on whether the power usage data is smoothed or the tendency curve of the data points in the power usage data is obtained in step S2106. Specifically, when the ratio is large enough, or the ratio r is larger over a ratio threshold, then the tendency curve of the data points in the power usage data is obtained in step S2106. Otherwise, the power usage data is smoothed in step S2106.

Referring to FIG. 3, in an embodiment of the present invention, the processing unit 120 also selectively time-shifts at least one of the power usage data (step S2108), such that the power usage data are aligned on the same timeline with the sampling times of the data points.

Referring to FIG. 1 and FIG. 2, after the processes, such as smoothing, time-shifting, are performed to the collected power usage data, the processing unit 120 calculates the dissimilarity between every two of the collected power usage data (step S220).

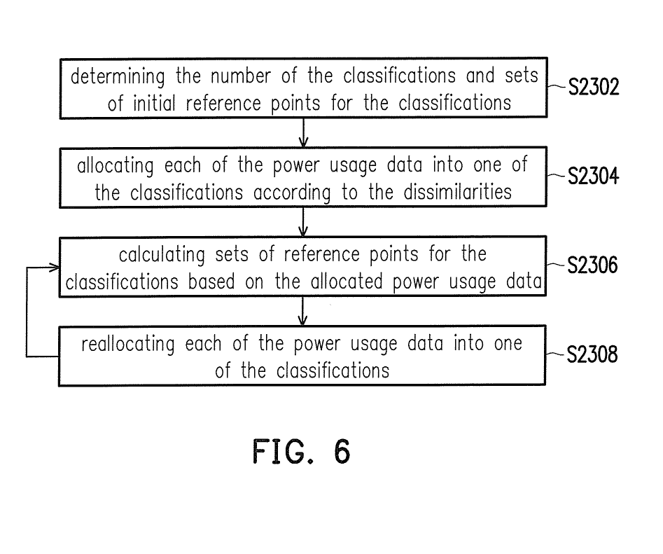

FIG. 5 is a flowchart illustrating calculating a dissimilarity according to an embodiment of the present invention. Referring to FIG. 5, the processing unit 120 first calculates a product between each pair of the data points collected at a corresponding timing from the two collected data (step S2202), and sums up all the products to obtain a sum of product between the two collected power usage data (step S2204). To be more specific, for example, the sum of product PRD of the power usage data Da and the power usage data Db is obtained as follows.

PRD=x_{Da1}×x_{Db1}+x_{Da2}×x_{Db2}+x_{Da3}×x_{Db3}+ . . . +x_{Dan}×x_{Dbn} (7)

It should be noted that, x_{Da1}, x_{Da2}, . . . , x_{Dan} are the data points of the power usage data Da, and x_{Db1}, x_{Db2}, . . . , x_{Dbn} are the data points of the power usage data Db, where n is the positive integer and represents the total number of the data points. The pairs of data points, such as the pair of data points x_{Da1}, x_{Db1} and the pair of data points x_{Dan}, x_{Dbn}, are respectively recorded and collected by the power usage recording devices PURD and the electronic apparatus 100 at the corresponding timing.

Moreover, the processing unit 120 calculates a first square root of sum of squares (SRSS) of the data points from one of the two collected power usage data (step S2206), and calculates a second SRSS of the data points from another one of the two collected power usage data (step S2208). To be more specific, for example, the first SRSS SRSS_{Da} of the power usage data Da and the second SRSS SRSS_{Db} of the power usage data Db are obtained as follows.

$$\begin{matrix}{SRSS}_{Da} = \sqrt{{( {X}_{Da 1} )}^{2} + {( {X}_{Da 2} )}^{2} + … + {( {X}_{Dan} )}^{2}} & ( 8 ) \\ {SRSS}_{Db} = \sqrt{{( {X}_{Db 1} )}^{2} + {( {X}_{Db 2} )}^{2} + … + {( {X}_{Dbn} )}^{2}} & ( 9 )\end{matrix}$$

After the first SRSS and the second SRSS of the power usage data are obtained, the processing unit 120 calculates an SRSS product of the first SRSS and the second SRSS (step S2210), divides the sum of product by the SRSS product to obtain a result value (step S2212), and then obtains the dissimilarity between two of the collected power usage data by subtracting the result value from 1 (step S2214). To be more specific, for example, the SRSS product SRSSPRD of the first SRSS SRSS_{Da} of the power usage data Da and the second SRSS SRSS_{Db} of the power usage data Db is obtained as follows.

SRSSPRD=SRSS_{Da}×SRSS_{Db} (10)

Moreover, the result value RV is obtained as follows.

$$RV = \frac{PRD}{SRSSPRD} \qquad ( 11 )$$

The result value is varied with the sum of product, the first SRSS and the second SRSS. In one embodiment of the present invention, when the one of the first SRSS and the second SRSS is 0, the result value is set to be 0. In contrast, when both of the first SRSS and the second SRSS are 0, the result value is set to be 1. At last, the dissimilarity DISSIM between two of the collected power usage data Da, Db is obtained as follows.

DISSIM=1−RV (12)

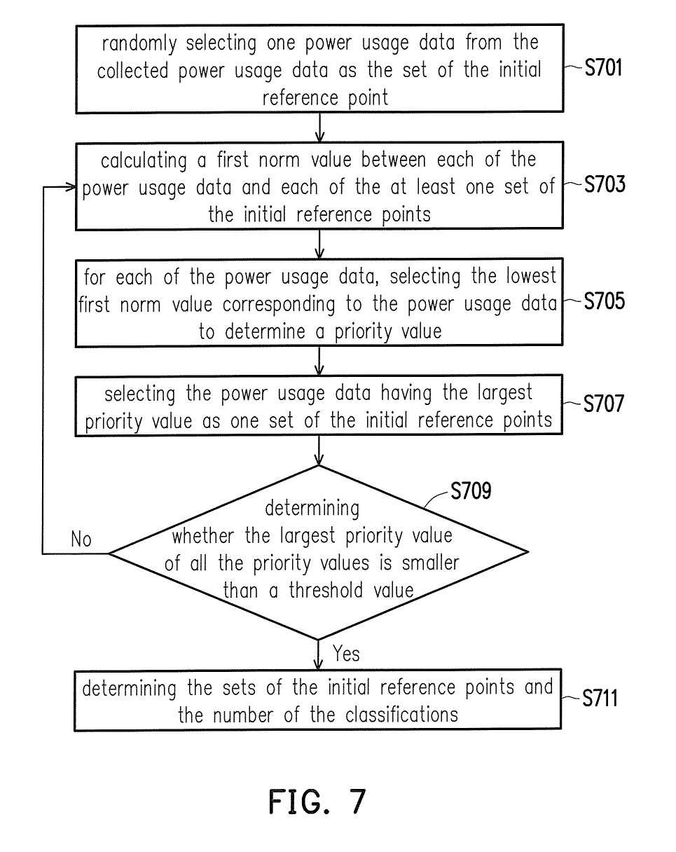

By applying the steps S2202-S2214 shown in FIG. 5, the processing unit 120 obtains the plurality of dissimilarities from the collected power usage data. Referring to FIG. 2, after the dissimilarities are obtained, the processing unit 120 classifies the collected power usage data into a plurality of classifications according to the dissimilarities (step S230). FIG. 6 is a flowchart illustrating classifying the collected power usage data into the plurality of classifications according to an embodiment of the present invention.

Referring to FIG. 6, the processing unit 120 determines the number of the classifications and sets of initial reference points for the classifications (step S2302). Specifically, each of the classification is corresponding to one of the sets of the initial reference points.

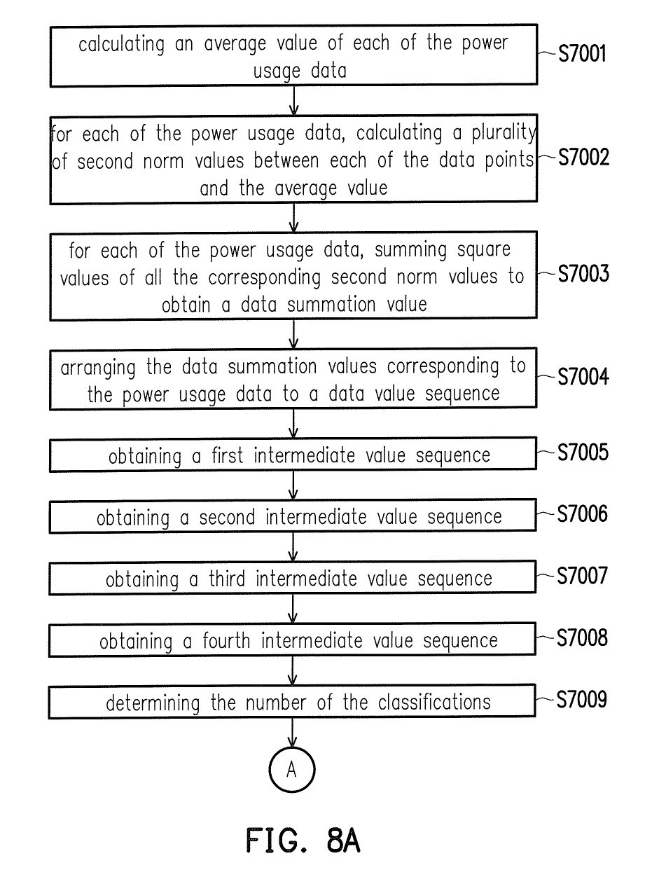

FIG. 7 is a flowchart illustrating determining the number of the classifications and the sets of the initial reference points according to an embodiment of the present invention. Referring to FIG. 7, in the present embodiment, the processing unit 120 randomly selects one power usage data from the collected power usage data as the set of the initial reference points (step S701, also the step (a)). In other words, the processing unit 120 randomly selects the data points of one of the collected power usage data as the initial reference points.

Next, the processing unit 120 calculates a first norm value between each of the power usage data and each of the at least one set of the initial reference points (step S703, also the step (b)). It should be noted that, each of the power usage data is corresponding to at least one first norm value. In other words, the actual number of the first norm value that one power usage data corresponds to is depending on the number of the set of the initial reference points. For example, when there are two sets of the initial reference points, after the step S703, each of the power usage data is corresponding to two first norm values.

In addition, after the plurality of first norm values are obtained, the processing unit 120 selects the lowest first norm value corresponding to the power usage data to determine a priority value for each of the power usage data (step S705, also the step (c)). To be more specific, after the step S703, if each of the power usage data is only corresponding to one first norm value, then the priority value of each of the power usage data is a square value of the first norm value. However, if each of the power usage data is corresponding to two or more first norm values, then the priority value of each of the power usage data is determined according to the lowest first norm value.

To be more specific, in the present embodiment, the priority value is a square value of the lowest first norm value corresponding to the power usage data when the number of the set of the initial reference points is lower than 3. However, when the number of the set of the initial reference points is not lower than 3, the priority value is then become a division of the square value of the lowest first norm value and a sum of the square values of the first norm values corresponding to the power usage data.

The processing unit 120 further selects the power usage data having the largest priority value as one set of the initial reference points (step S707, also the step (d)), and the processing unit 120 determines whether the largest priority value of all the priority values is smaller than a threshold value (step S709, also the step (e)). If the largest priority value is not smaller than the threshold value, the processing unit 120 again executes the steps S703-S709 shown in FIG. 7. It is obvious that, the number of the sets of the initial reference points is dependent on how many times the steps S703-S709 are performed by the processing unit 120. The more the steps S703-S709 are performed, the more the sets of the initial reference points are obtained. However, once the largest priority value is determined to be smaller than the threshold value in the step S709, the processing unit 120 then determines the sets of the initial reference points, and the number of the sets of the initial reference points is the number of the classifications (step S711).

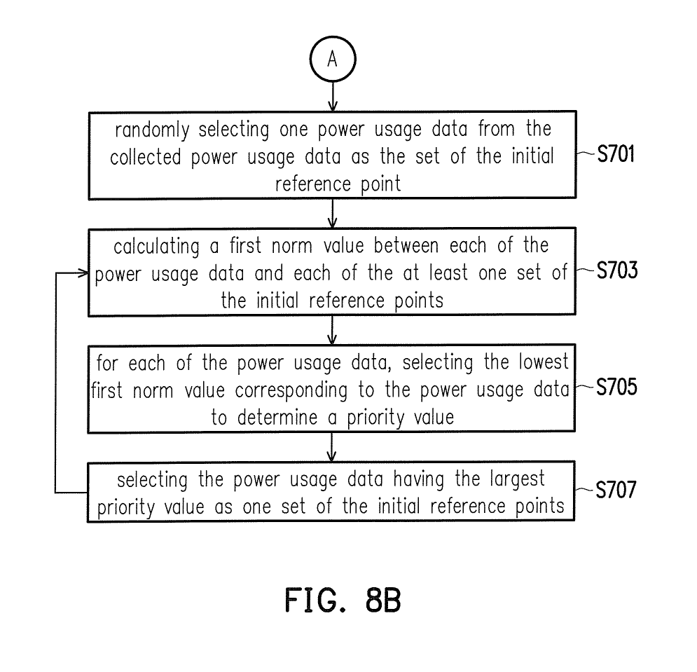

However, in the present invention, the method of determining the number of the classifications and the sets of the initial reference points is not limited to the embodiment shown in FIG. 7. FIG. 8A and FIG. 8B are a flowchart illustrating determining the number of the classifications and the sets of the initial reference points according to another embodiment of the present invention.

Referring to FIG. 8A and FIG. 8B, in the present embodiment, the processing unit 120 first determines the number of the classifications, and in following determines the sets of the initial reference points for the classifications. Before randomly selecting one power usage data from the collected power usage data as the set of the initial reference points (step S701, also the step (a)), the processing unit 120 calculates an average values of each of the power usage data (step S7001), such that the plurality of the average values corresponding to the power usage data are obtained. For each of the power usage data, the processing unit 120 calculates a plurality of second norm values between each of the data points and the average value (step S7002). In addition, for each of the power usage data, the processing unit 120 sums square values of all the corresponding second norm values to obtain a data summation value (step S7003), and arranges the data summation values corresponding to the power usage data into a data value sequence (step S7004). The processing unit 120 then obtains a first intermediate value sequence (step S7005) from the data value sequence. To be more specific, for example, the first intermediate value sequence E′₁ is obtained as follows.

E′₁(b)=Σ_{i′=1}^{b}Σ_{xεD}_{_{i′}}∥x−μ_{i′}∥² (13)

It should be noted that, D_{i′} represents the i′ₜₕ power usage data, μ_{i′} is the average value of the data points x of the power usage data D_{i′}, b is the positive integer which is equal to the number of the power usage data, and i′ may be 1 to b. All the data summation values Σ_{xεD}_{_{i′}}∥x−μ_{i′}∥² are arranged into the data value sequence by the processing unit 120, and the first intermediate value sequence E′₁ is obtained from the data value sequence. Specifically, the bₜₕ term of the first intermediate value sequence E′₁ is a total summation value of first term to bₜₕ term of the data value sequence.

After the first intermediate value sequence E′₁ is obtained, the processing unit 120 obtains a second intermediate value sequence E′₂ (step S7006). To be more specific, for example, the second intermediate value sequence E₂¹ is obtained as follows.

E′₂(l)=∥E′₁(l+1)−E′₁(l)∥² (14)

It should be noted that, l is the positive integer, the lₜₕ term of the second intermediate value sequence E′₂ is a square value of a third norm value between the (l+1)ₜₕ term and the lₜₕ, term of the first intermediate value sequence E′₁.

Moreover, after the second intermediate value sequence E′₂ is obtained, the processing unit 120 obtains a third intermediate value sequence E′₃ (step S7007). To be more specific, for example, the third intermediate value sequence E′₃ is obtained as follows.

E′₃(m)=∥E′₂(m+1)−E′₂(m)∥² (15)

It should be noted that, m is the positive integer, the mₜₕ term of the third intermediate value sequence E′₃ is a square value of a fourth norm value between the (m+1)ₜₕ term and the mₜₕ term of the second intermediate value sequence E′₃.

After the third intermediate value sequence E′₃ is obtained, the processing unit 130 obtains a fourth intermediate value sequence E′₄ (step S7008). To be more specific, for example, the fourth intermediate value sequence E′₄, is obtained as follows.

E′₄(q)=∥E′₃(q+1)−E′₃(q)∥² (16)

It should be noted that, q is the positive integer, the qₜₕ term of the fourth intermediate value sequence E′₄ is a square value of a fifth norm value between the (q+1)ₜₕ term and the qₜₕ term of the third intermediate value sequence E′₃.

Last, the processing unit 120 determines the number of the classifications (step S7009). The number of the classifications is the q which results the maximum square value of the fifth norm value. To be more specific, for example, the q which results the maximum square value of the fifth norm value is obtained as follows.

q=arg max_{q}∥E′₃(q+1)−E′₃(q)∥² (17)

In the present embodiment, once the number of the classifications is determined, the steps S701-S707 are then executed by the processing unit 120. The steps S703 to S707 are repeatedly executed until the number of the sets of the initial reference points equals to the number of the classifications. It should be noted that, in the embodiment shown by FIG. 8A and FIG. 8B, the priority value is simply the square value of the lowest first norm value corresponding to the power usage data.

Referring to FIG. 6, after the number of the classifications and sets of initial reference points for the classifications are determined, the processing unit 120 allocates each of the power usage data into one of the classifications according to the dissimilarities (step S2304). A distortion between the allocated power usage data and the set of the initial reference points of the classification which the power usage data belonging to is lower than the distortion between the allocated power usage data and the at least one set of the initial reference points of the other classification which the power usage data is not belonging to. In other words, the data points of the power usage data are closer to the initial reference points of the classification which the power usage data belonging to than the at least one set of the initial reference points of the other classification which the power usage data is not belonging to.

The processing unit 120 further calculates sets of reference points for the classifications based on the allocated power usage data (step S2306). Specifically, since each of the classifications has at least one power usage data belonging to, the processing unit 120 recalculates set of reference points as the center for each of the classifications based on the allocated power usage data. That is to say, for one classification, the processing unit 120 calculates the set of the reference points based on its own power usage data, so as to find the center of the classification. The sum of the at least one distortion between the allocated power usage data and the set of the reference points of the classification should be the minimum value.

After the sets of the reference points of the classifications are obtained, the processing unit 120 reallocates each of the power usage data into one of the classifications (step S2308). The distortion between the reallocated power usage data and the set of the reference points of the classification which the reallocated power usage data belonging to is lower than the distortion between the reallocated power usage data and the at least one set of the reference points of the other classification which the reallocated power usage data not belonging to.

It should be noted that, the step of calculating the sets of reference points for the classifications based on the allocated power usage data (step S2306) and the step of reallocating each of the power usage data into one of the classifications (step S2308) are repeatedly performed by the processing unit 120 until distortions between each of the reallocated power usage data and the set of the reference points of the corresponding classification which the reallocated power usage data belonging to are not being decreased. Under such condition, even the steps S2306 and S2308 are performed by the processing unit 120, the sets of the reference points and the allocation of the power usage data are not changed.

Referring to FIG. 2, after the collected power usage data is classified, the display unit 130 displays the power usage data (step S240), wherein the power usage data belonging to the different classifications are shown by different colors.

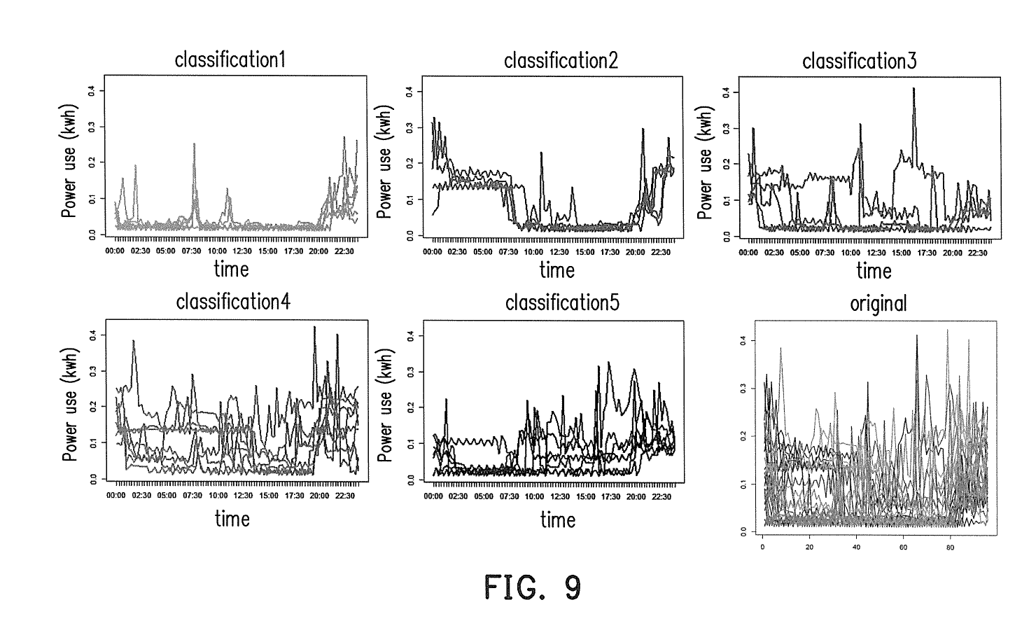

FIG. 9 is a schematic diagram illustrating the power usage data respectively allocated in each of the classifications according to an embodiment of the present invention. Referring to FIG. 9, without classifying, all the power usage data displayed together (as shown in the plot labeled Original) are in a mess.

In the present embodiment, the processing unit 120 selects the colors from a color space according to the number of the classifications. This is to say, the number of the selected colors is equal to the number of the classifications. Each of the selected colors has greatest difference to other selected colors in the color space, and the color space is, for example, a red-green-blue (RGB) color space or a hue-saturation-lightness (HSL) color space.

The display unit 130 displays the power usage data in one of the classifications with one of the selected colors, such that the colors of the classifications are different. Further, for each of the classifications, the horizontal axis represents the time (0:00˜24:00, 24-hour time notation), and the vertical axis represents the power use (kilowatt hour, kWh). As the result, the power usage data having the similar patterns are put into the same classification and displayed with the same color.

Since each of the power usage data may contain a large number of the data points, completely displaying all the data points of the power usage data by the display unit 130 may cause adverse effect on viewing the power usage data. Therefore, in an embodiment of the present invention, the processing unit 120 applies multidimensional scaling on each of the power usage data to obtain a plurality of representative points in a two-dimensional space, and the display unit 130 displays the scattering plot and the presentative points in the scattering plot.

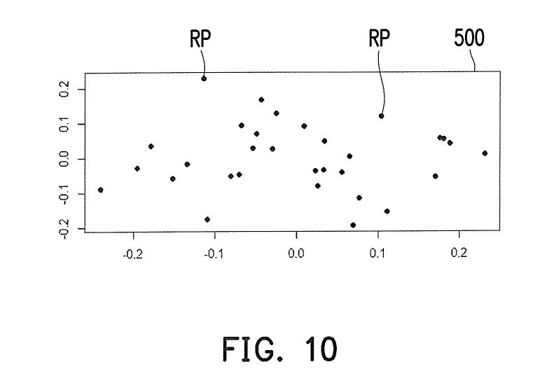

FIG. 10 is a schematic diagram illustrating a scattering plot with representative points according to an embodiment of the present invention. Referring to FIG. 10, each of the representative points RP represents to one of the power usage data. The horizontal axis and the vertical axis of the scattering plot 500 simply represent the range for displaying all the representative points RP. Further, the distance between two of the representative points RP is related to the similarity of the two of the representative points RP. The scattering plot 500 clearly shows all the representative points RP.

The representative points RP shown by the display unit 130 may be selected through the control interface 150. If a user of the electronic apparatus 100 is intended to view the detailed power usage data of some of the representative points RP, the user mat select those representative points RP through the control interface 150. The processing unit 120 may search the power usage data corresponding to the selected representative points RP, and the display unit 130 may display the searched power usage data.

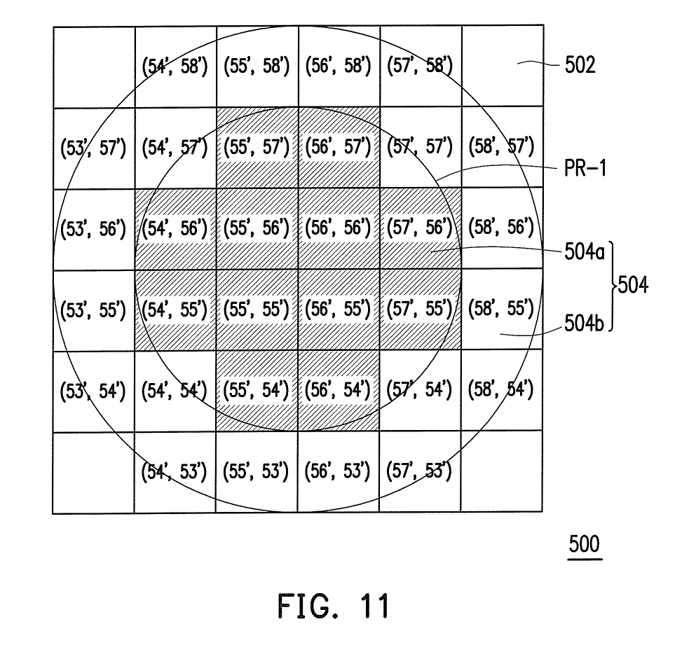

FIG. 11 is a schematic diagram illustrating a representative point according to an embodiment of the present invention. In an embodiment of the present invention, the scattering plot 500 is divided into a plurality of grids 502, and each of the grids 502 includes a plurality of pixels. In addition, each of the representative points RP occupies a first region 504a of the grids 502.

In FIG. 11, one of the representative point RP, for example, the representative point RP-1 set by the processing unit 120 occupies a first region 504a of the grids 502. To be more specific, the grids 502 labeled with (54′, 55′), (54′, 56′), (55′, 54′), (55′, 55′), (55′, 56′), (55′, 57′), (56′, 54′), (56′, 55′), (56′, 56′), (56′, 57′), (57′, 55′), (57′, 56′) are belonged to the first region 504a. The processing unit 120 further sets a detection range 504 of the representative point RP-1, which covers the first region 504a and a second region 504b of the grids 502 around the first region 504a. As shown in FIG. 11, the grids 502 labeled with (53′, 54′), (53′, 55′), (53′, 56′), (53′, 57′), (54′, 53′), (54′, 54′), (54′, 57′), (54′, 58′), (55′, 53′), (55′, 58′), (56′, 53′), (56′, 58′), (57′, 53′), (57′, 54′), (57′, 57′), (57′, 58′), (58′, 54′), (58′, 55′), (58′, 56′), (58′, 57′) are belonged to the second region 504b.

The processing unit 120 sets the detection ranges 504 for all the representative points RP on the scattering plot 500 and records the representative points RP and the corresponding detection ranges 504 on the scattering plot 500 in the storage unit 140 as a table. An example of the table is shown below.

TABLE 1

| Grid | Representative point | Indicator |
|---|---|---|
| . | . | . |
| . | . | . |
| . | . | . |
| (53′, 54′) | RP-1 | 0 |
| (53′, 55′) | RP-1 | 0 |
| . | . | . |
| . | . | . |
| . | . | . |
| (55′, 55′) | RP-1 | 1 |
| (55′, 56′) | RP-1 | 1 |
| (55′, 57′) | RP-1 | 1 |
| . | . | . |
| . | . | . |
| . | . | . |
| (57′, 57′) | RP-1 | 0 |
| (57′, 58′) | RP-1 | 0 |
| . | . | . |
| . | . | . |
| . | . | . |

As in the Table 1, each of the grids 502 corresponds to one of the representative points RP. In the present embodiment, Table 1 only records the girds 502 that correspond to the representative points RP. In other words, Table 1 only records the grids 502 that is in the detection ranges 504 of the representative points RP. The Indicator is applied for indicating whether the grid 502 is in the first region 504a of the corresponding representative point RP or not. For example, referring to FIG. 11, the grid labeled (55′, 55′) is in the first region 504a of the representative point RP-1, so the Indicator has the value that is 1. By contrast, the grid labeled (57′, 57′) is in the second region 504b of the representative point RP-1, so the Indicator has the value that is 0.

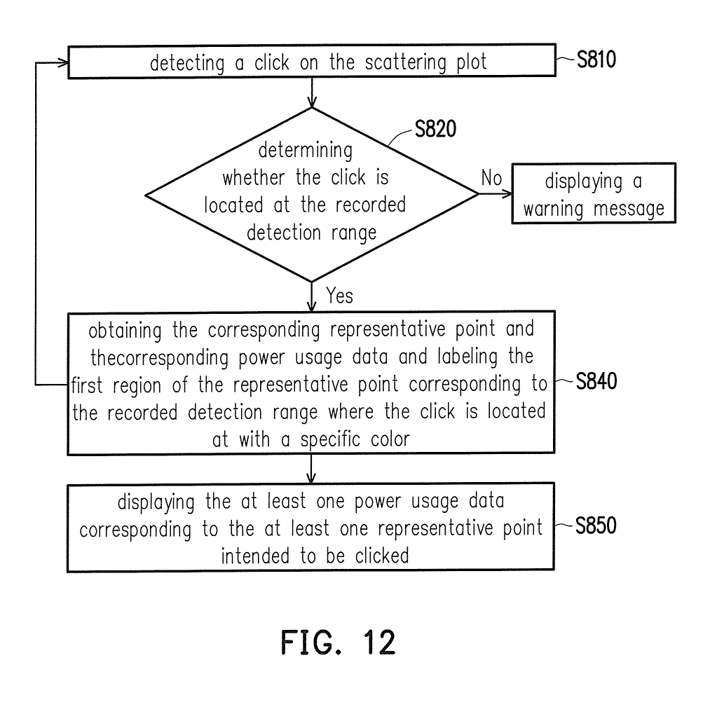

FIG. 12 is a flowchart illustrating displaying power usage data corresponding to the selected representative point according to an embodiment of the present invention. Referring to FIG. 12, in an embodiment of the present invention, while the scattering plot 500 and the representative points RP are displayed by the display unit 130, the processing unit 120 continuously detects whether any control operation, such as a click, to the scattering plot 500 and the representative points RP is performed on the control interface 150.

Once the processing unit 120 detects a click on the scattering plot 500 through the control interface 150 (step S810), the processing unit 120 determines whether the click is located at the recorded detection range 540 in the storage unit 140 (step S820). If the click is not located at the recorded detection range 540, the processing unit 120 controls the display unit 130 to display a warning message (step S830). However, if the click is located at the recorded detection range 540, the processing unit 120 obtains the corresponding representative point RP and the corresponding power usage data, and further labels the first region of the representative point RP corresponding to the recorded detection range 540 where the click is located at with a specific color to point out the selected representative point RP (step S840).

The processing unit 120 may response to the clicks respectively located at multiple recorded detection ranges, which means that the user of the electronic apparatus 100 is intended to select more than one of the representative points RP. After the selection is finished, the display unit 130 displays the at least one power usage data corresponding to the at least one representative point RP intended to be clicked (step S850). The user may click on a button shown by the display unit 130 to inform the electronic apparatus 100 that the selection of the representative points RP is over. Once the processing unit 120 detects that the button is clicked, the processing unit 120 controls the display unit 130 displays the power usage data corresponding to the selected representative points RP. The power usage data within different classifications are displayed by different colors.

In summary, in the method of analyzing power usage and the electronic apparatus thereof, power usage data are collected, and the dissimilarity between every two of the power usage data is calculated. The collected power usage data are further classified according to the calculated dissimilarities and displayed. As the result, the power usage data having the similar patterns are put into the same classification and visualized with the same color. Thus, large amount of the power usage data is effectively arranged, classified and further displayed through the power usage analysis method and the electronic apparatus provided in the present invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method of analyzing power usage, adapted to an electronic apparatus, comprising:
collecting power usage data from power usage recording devices within a time interval, wherein each of the power usage data includes a plurality of data points;
calculating a dissimilarity between every two of the collected power usage data;
classifying the collected power usage data according to the dissimilarities into a plurality of classifications; and
displaying the power usage data, wherein the power usage data belonging to the different classifications are shown by different colors.

2. The method of analyzing power usage according to claim 1, wherein step of collecting the power usage data further comprises:
collecting the data points from the power usage recording devices recorded once every period within the time interval to obtain the power usage data.

3. The method of analyzing power usage according to claim 1, wherein the step of calculating the dissimilarity between two of the collected power usage data further comprises:
calculating a product between each pair of the data points collected at a corresponding timing from the two collected power usage data;
summing all the products to obtain a sum of product between the two collected power usage data;
calculating a first square root of sum of squares (SRSS) of the data points from one of the two collected power usage data;
calculating a second SRSS of the data points from another one of the two collected power usage data;
calculating an SRSS product of the first SRSS and the second SRSS;
dividing the sum of product by the SRSS product to obtain a result value; and
obtaining the dissimilarity between two of the collected power usage data by subtracting the result value from 1.

4. The method of analyzing power usage according to claim 3, wherein when one of the first SRSS and the second SRSS is 0, the result value is set to be 0, and when both of the first SRSS and the second SRSS are 0, the result value is set to be 1.

5. The method of analyzing power usage according to claim 1, wherein before calculating the dissimilarity between every two of the collected power usage data, the method further comprises:
determining a ratio to obtain a selected number from a total number of the data points within the single collected power usage data;
obtaining a group of weightings, wherein the number of the weightings equals to the selected number, and a distribution of the weightings is corresponding to a bell shape;
utilizing the weightings to selectively smooth the power usage data or to selectively obtain a tendency curve of the data points in each of the power usage data; and
selectively time-shifting at least one of the power usage data.

6. The method of analyzing power usage according to claim 1, wherein the step of classifying the collected power usage data into the plurality of classifications further comprises:
determining the number of the classifications and sets of initial reference points for the classifications, wherein each of the classifications is corresponding to one of the sets of the initial reference points;
allocating each of the power usage data into one of the classifications according to the dissimilarities, wherein a distortion between the allocated power usage data and the set of the initial reference points of the classification which the power usage data belonging to is lower than the distortion between the allocated power usage data and the at least one set of the initial reference points of the other classification;
calculating sets of reference points for the classifications based on the allocated power usage data, wherein each of the classifications is corresponding to one of the sets of the reference points; and
reallocating each of the power usage data into one of the classifications, wherein the distortion between the reallocated power usage data and the set of the reference points of the classification which the reallocated power usage data belonging to is lower than the distortion between the reallocated power usage data and the at least one set of the reference points of the other classification.

7. The method of analyzing power usage according to claim 6, wherein the step of determining the number of the classifications and the sets of the initial reference points for classifications further comprises:
(a). randomly selecting one power usage data from the collected power usage data as the set of the initial reference points;
(b). calculating a first norm value between each of the power usage data and each of the at least one set of the initial reference points, wherein each of the power usage data is corresponding to the at least one first norm value;
(c). for each of the power usage data, selecting the lowest first norm value corresponding to the power usage data to determine a priority value; and
(d). selecting the power usage data having the largest priority value as one set of the initial reference points.

8. The method of analyzing power usage according to claim 7, wherein the step of determining the number of the classifications and the sets of the initial reference points for classifications further comprises:
(e). determining whether the largest priority value of all the priority values is smaller than a threshold value,
wherein if the largest priority value is smaller than the threshold value, the sets of the initial reference points are determined, and the number of the sets of the initial reference points is the number of the classifications,
wherein if the largest priority value is not smaller than the threshold value, the steps (b) to (e) are executed again.

9. The method of analyzing power usage according to claim 8, wherein the priority value is a square value of the lowest first norm value corresponding to the power usage data when the number of the set of the initial reference points is lower than 3, and the priority value is a division of the square value of the lowest first norm value and a sum of the square values of the first norm values corresponding to the power usage data when the number of the set of the initial reference points is not lower than 3.

10. The method of analyzing power usage according to claim 7, wherein before the step (a), the method further comprises:
calculating an average value of each of the power usage data;
for each of the power usage data, calculating a plurality of second norm values between each of the data points and the average value;
for each of the power usage data, summing square values of all the corresponding second norm values to obtain a data summation value;
arranging the data summation values corresponding to the power usage data to a data value sequence;
obtaining a first intermediate value sequence, wherein bₜₕ term of the first intermediate value sequence is a total summation value of first term to bₜₕ term of the data value sequence;
obtaining a second intermediate value sequence, wherein lₜₕ term of the second intermediate value sequence is a square value of a third norm value between the (l+1)ₜₕ term and the lₜₕ term of the first intermediate value sequence;
obtaining a third intermediate value sequence, wherein mₜₕ term of the third intermediate value sequence is a square value of a fourth norm value between the (m+1)ₜₕ term and the mₜₕ terra of the second intermediate value sequence;
obtaining a fourth intermediate value sequence, wherein qₜₕ term of the fourth intermediate value sequence is a square value of a fifth norm value between the (q+1)ₜₕ term and the qₜₕ term of the third intermediate value sequence; and
determining the number of the classifications, wherein the number of the classification is the q which results the maximum square value of the fifth norm value, b, l, q are positive integers, and b is equal to the number of the power usage data,
wherein the steps (b) to (d) are repeatedly executed until the number of the sets of the initial reference points equals to the number of the classifications.

11. The method of analyzing power usage according to claim 6, wherein the step of calculating the sets of reference points for the classifications based on the allocated power usage data and the step of reallocating each of the power usage data into one of the classifications are repeated until the distortions between each of the reallocated power usage data and the set of the reference points of the corresponding classification which the reallocated power usage data belonging to are not being decreased.

12. The method of analyzing power usage according to claim 1, wherein the step of displaying the power usage data further comprises:
selecting the colors from a color space according to the number of the classifications, wherein the number of the selected colors is equal to the number of the classifications, and each of the selected colors has greatest difference to other selected colors; and
displaying the power usage data in one of the classifications with one of the selected colors, wherein the colors of the classifications are different.

13. The method of analyzing power usage according to claim 1, wherein the step of displaying the power usage data further comprises:
applying multidimensional scaling on each of the power usage data to obtain a plurality of representative points in a two-dimensional space;
displaying the representative points in a scattering plot, wherein the scattering plot is divided into a plurality of grids, each of the grids includes a plurality of pixels, and each of the representative points occupies a first region of the grids;
setting a detection range for each of the representative points on the scattering plot, wherein the detection range covers the first region of the grids and a second region of the grids around the first region; and
recording the representative points and the corresponding detection ranges on the scattering plot.

14. The method of analyzing power usage according to claim 13, further comprises:
detecting a click on the scattering plot;
determining whether the click is located at the recorded detection range;
if the click is not located at the recorded detection range, displaying a warning message;
if the click is located at the recorded detection range, obtaining the corresponding representative point and the corresponding power usage data and labeling the first region of the representative point corresponding to the recorded detection range where the click is located at with a specific color; and
displaying the at least one power usage data corresponding to the at least one representative point intended to be clicked.

15. An electronic apparatus, comprising:
a transmission unit, connected to power usage recording devices, collecting power usage data from the power usage recording devices within a time interval, wherein each of the power usage data includes a plurality of data points;
a processing unit, calculating a dissimilarity between every two of the collected power usage data, and classifying the collected power usage data according to the dissimilarities into a plurality of classifications; and
a display unit, displaying the power usage data, wherein the power usage data belonging to the different classifications are shown by different colors.

16. The electronic apparatus according to claim 15, wherein the transmission unit collects the data points from the power usage recording devices recorded once every period within the time interval to obtain the power usage data.

17. The electronic apparatus according to claim 15, wherein the processing unit calculates a product between each pair of the data points collected at a corresponding timing from the two collected power usage data, sums all the products to obtain a sum of product between the two collected power usage data, calculates a first square root of sum of squares (SRSS) of the data points from one of the two collected power usage data, calculates a second SRSS of the data points from another one of the two collected power usage data, calculates an SRSS product to obtain a result value and obtains the dissimilarity between two of the collected power usage data by subtracting the result value from 1.

18. The electronic apparatus according to claim 17, wherein when one of the first SRSS and the second SRSS is 0, the result value is set to be 0, and when both of the first SRSS and the second SRSS are 0, the result value is set to be 1.

19. The electronic apparatus according to claim 15, wherein before calculating the dissimilarity between every two of the collected power usage data, the processing unit determines a ratio to obtain a selected number from a total number of the data points within the single collected power usage data, obtains a group of weightings where the number of the weightings equals to the selected number and a distribution of the weightings is corresponding to a bell shape, utilizes the weightings to selectively smooth the power usage data or to selectively obtain a tendency curve of the data points in each of the power usage data, and selectively time-shifts at least one of the power usage data.

20. The electronic apparatus according to claim 15, wherein the processing unit determines the number of the classifications and sets of initial reference points for the classifications where each of the classifications is corresponding to one of the sets of the initial reference points, and allocates each of the power usage data into one of the classifications according to the dissimilarities, where a distortion between the allocated power usage data and the set of the initial reference points of the classification which the power usage data belonging to is lower than the distortion between the allocated power usage data and the at least one set of the initial reference points of the other classification,
the processing unit further calculates sets of reference points for the classifications based on the allocated power usage data where each of the classifications is corresponding to one of the sets of the reference points, and reallocates each of the power usage data into one of the classifications, where the distortion between the reallocated power usage data and the set of the reference points of the classification which the reallocated power usage data belonging to is lower than the distortion between the reallocated power usage data and the at least one set of the reference points of the other classification.

21. The electronic apparatus according to claim 20, wherein the processing unit (a) randomly selects one power usage data from the collected power usage data as the set of the initial reference points, (b) calculates a first norm value between each of the power usage data and each of the at least one set of the initial reference points, wherein each of the power usage data is corresponding to the at least one first norm value, (c) selects the lowest first norm value corresponding to the power usage data to determine a priority value for each of the power usage data, and (d) selects the power usage data having the largest priority value as one set of the initial reference points.

22. The electronic apparatus according to claim 21, wherein the processing unit (e) determines whether the largest priority value of all the priority values is smaller than a threshold value,
if the largest priority value is smaller than the threshold value, the processing unit determines the sets of the initial reference points, and the number of the sets of the initial reference points is the number of the classifications,
if the largest priority value is not smaller than the threshold value, the processing unit executes the steps (b) to (e) again.

23. The electronic apparatus according to claim 22, where the priority value is a square value of the lowest first norm value corresponding to the power usage data when the number of the set of the initial reference points is lower than 3, and the priority value is a division of the square value of the lowest first norm value and a sum of the square values of the first norm values corresponding to the power usage data when the number of the set of the initial reference points is not lower than 3.

24. The electronic apparatus according to claim 20, wherein before executing the step (a), the processing unit calculates an average value of each of the power usage data, calculates a plurality of second norm values between each of the data points and the average value for each of the power usage data, sums square values of all the corresponding second norm values to obtain a data summation value for each of the power usage data, arranges the data summation values corresponding to the power usage data to a data value sequence, obtains a first intermediate value sequence, where bₜₕ term of the first intermediate value sequence is a total summation value of first term to bₜₕ term of the data value sequence, obtains a second intermediate value sequence, where lₜₕ term of the second intermediate value sequence is a square value of a third norm value between the (l+1)ₜₕ term and the lₜₕ term of the first intermediate value sequence, obtains a third intermediate value sequence, wherein mₜₕ term of the third intermediate value sequence is a square value of a fourth norm value between the (m+1)ₜₕ term and the mₜₕ term of the second intermediate value sequence, obtains a fourth intermediate value sequence, wherein qₜₕ term of the fourth intermediate value sequence is a square value of a fifth norm value between the (q+1)ₜₕ term and the qₜₕ term of the third intermediate value sequence, and determines the number of the classifications, where the number of the classification is the q which results the maximum square value of the fifth norm value, b, l, q are positive integers, b is equal to the number of the power usage data,
and the processing unit repeatedly executes the steps (b) to (d) until the number of the sets of the initial reference points equals to the number of the classifications.

25. The electronic apparatus according to claim 20, wherein the processing unit repeatedly calculates the sets of reference points for the classifications based on the allocated power usage data and reallocates each of the power usage data into one of the classifications until the distortions between each of the reallocated power usage data and the set of the reference points of the corresponding classification which the reallocated power usage data belonging to are not being decreased.

26. The electronic apparatus according to claim 15, wherein the processing unit selects the colors from a color space according to the number of the classifications, where the number of the selected colors is equal to the number of the classifications, and each of the selected colors has greatest difference to other selected colors, the display unit displaying the power usage data in one of the classifications with one of the selected colors, where the colors of the classifications are different.

27. The electronic apparatus according to claim 15, wherein the electronic apparatus further includes a storage unit,
the processing unit applies multidimensional scaling on each of the power usage data to obtain a plurality of representative points in a two-dimensional space, and the display unit displays the representative points in a scattering plot, wherein the scattering plot is divided into a plurality of grids, each of the grids includes a plurality of pixels, and each of the representative points occupies a first region of the grids,
the processing unit further sets a detection range for each of the representative points on the scattering plot and records the representative points and the corresponding detection ranges on the scattering plot in the storage unit, wherein the detection range covers the first region of the grids and a second region of the grids around the first region.

28. The electronic apparatus according to claim 27, wherein the electronic apparatus further includes a control interface,
the processing unit detects a click on the scattering plot through the control interface, and determines whether the click is located at the recorded detection range,
if the click is not located at the recorded detection range, the display unit displays a warning message,
if the click is located at the recorded detection range, the processing unit obtains the corresponding representative point and the corresponding power usage data and labels the first region of the representative point corresponding to the recorded detection range where the click is located at with a specific color, and the display unit displays the at least one power usage data corresponding to the at least one representative point intended to be clicked.
